(19) United States
(12) Patent Application Publication
(10) Pub. No.: US 2020/0097971 A1
(43) Pub. Date: Mar. 26, 2020

(54) HIGH-SECURITY TOGGLE SYSTEM FOR USE WITH PAYMENT INSTRUMENT DISPLAYS

(71) Applicant: Bank of America Corporation, Charlotte, NC (US)

(72) Inventors: Melissa Church, Charlotte, NC (US); Robert M. Voyles, Tustin, CA (US); Meggin A. Douthitt, Parrish, FL (US); Philip Chap, Yorba Linda, CA (US); Eric W. Doyle, Smithton, IL (US); James H. Loney, Charlotte, NC (US); Stacy A. Maschhoff, Huntersville, NC (US); Ashwin Borges, Newark, DE (US)

(21) Appl. No.: 16/193,076

(22) Filed: Nov. 16, 2018

Related U.S. Application Data
(60) Provisional application No. 62/734,376, filed on Sep. 21, 2018.

(51) Int. Cl. G06Q 20/40; G06Q 20/10; G06Q 20/36

(52) U.S. Cl. CPC G06Q 20/4014; G06Q 20/36; G06Q 20/1085; G06Q 20/4018

(57) ABSTRACT

Aspects of the disclosure relate to a high-security toggle system for use with payment instrument displays. The system may be toggle-able to display different subsets of a dataset associated with a payment instrument. The system may establish a level of verification status to allow the display of up to the full dataset. The full dataset may be displayed even prior to the activation of any tangible embodiment of the payment instrument.

### CROSS-REFERENCE TO RELATED APPLICATION

This application is a non-provisional of U.S. Provisional Patent Application No. 62/734,376 filed Sep. 21, 2018 entitled “HIGH-SECURITY TOGGLE SYSTEM FOR USE WITH PAYMENT INSTRUMENT DISPLAYS” which is hereby incorporated by reference herein in its entirety.

### FIELD OF TECHNOLOGY

Aspects of the disclosure relate to electronic displays. Specifically, aspects of the disclosure relate to high-security electronic displays with multiple modes.

### BACKGROUND OF THE DISCLOSURE

One popular use of computer systems includes displaying data. Computer systems well suited for such use include desktops, laptops, tablets, and mobile devices. Examples of mobile devices include phones and smart-watches.

Recent years have seen a proliferation in the computer-based display of sensitive data associated with payment instruments. The sensitive data may include account numbers, expiration dates, and card verification values (“CVV”). The sensitive data may be accessed for display, for example, via a website, computer program, or mobile application (“app”). Mobile applications may include banking or financial apps. A financial app may include a digital wallet.

Existing systems for displaying sensitive data associated with payment instruments are generally contingent on prior activation of a physically embodied payment instrument. Only once the physical payment instrument comes into the presence of a user can the user typically activate the payment instrument and/or an account associated with the payment instrument.

A user often desires to use, or access data associated with, a payment instrument as soon as the instrument is approved or created. A user may have time-sensitive expenses, bills, and purchases for which he or she wants to utilize the payment instrument.

There is a need, therefore, to provide high-security systems and methods for displaying data associated with a payment instrument prior to activation of a physical embodiment of the payment instrument.

### SUMMARY OF THE DISCLOSURE

Aspects of the disclosure relate to high-security toggle systems for use with payment instrument displays. One embodiment includes a toggle-able user interface (“TUI”) for displaying distinct subsets of a dataset.

The TUI may include a screen for displaying data and a verification module configured to receive a plurality of signals. The verification module may also establish a level of verification status. In response to a first signal, the verification module may upgrade the verification status from a default level to a first level. When the verification status is at the first level, the screen may display a first, partial, subset of the dataset.

In response to a second signal, the verification module may upgrade the verification status from the first level to a second level. When the verification status is at the second level, the screen may be augmented with the ability to toggle to display a second, sensitive, subset of the dataset.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows another illustrative system in accordance with principles of the disclosure;

FIG. 3 shows an illustrative flowchart in accordance with principles of the disclosure;

FIG. 4 shows an illustrative system in accordance with principles of the disclosure;

FIG. 5 shows another illustrative system in accordance with principles of the disclosure;

FIG. 6 shows yet another illustrative system in accordance with principles of the disclosure;

FIG. 7 shows still another illustrative system in accordance with principles of the disclosure; and

FIG. 8 shows another illustrative system in accordance with principles of the disclosure.

### DETAILED DESCRIPTION OF THE DISCLOSURE

Aspects of the disclosure relate to high-security toggle systems for use with payment instrument displays. One embodiment includes a toggle-able user interface (“TUI”) for instantaneously displaying distinct subsets of a dataset. The dataset may include information associated with the payment instrument. Instantaneous display may be substantially immediately after a payment instrument is initialized. In some embodiments, instantaneous display may include any time prior to receipt and activation of a tangible payment instrument. In yet other embodiments, the display may be at any time after a payment instrument is initialized. The dataset may include data associated with the payment instrument. The TUI may include multiple levels of verification for high-security toggle-ability for instantaneous access to sensitive portions of the dataset.

The TUI may include a screen for displaying data. The screen may form a part of a computing device. Computing devices may include desktops, laptops, tablet computers, mobile phones, and smart-watches. The screen may form part of a dedicated payment instrument device. The screen may include an array of organic light emitting diodes (OLED). An OLED screen may be bendable.

The TUI may also include a verification module configured to receive a plurality of signals. The verification module may also establish a level of verification status. In response to a first signal, the verification module may upgrade the verification status from a default level to a first level. When the verification status is at the first level, the screen may display a first, partial, subset of the dataset.

In response to a second signal, the verification module may upgrade the verification status from the first level to a second level. When the verification status is at the second level, the screen may be augmented with the ability (e.g. in the form of a selectable option) to toggle to display a second, sensitive, subset of the dataset.

Toggling the screen to display the second subset may be automatic. For example, when the second verification level has been achieved, the screen may display the second subset independent of any prompting. Alternatively, even when the second verification level has been achieved, the screen may only display the second subset in response to a prompt. An example of a prompt may include selecting an option on the screen. Selecting an option may include pressing a button, clicking an icon, or any other suitable manner of selecting an option.

One example of a TUI may include a mobile application (“app”) on a smart phone. The phone may initialize with a default verification level. A user may perform a first action that qualifies as a first signal. The first signal may establish a first verification level and allow access to an app. The app may display a portion of a dataset. A user may perform a second action that qualifies as a second signal. The second signal may establish a second verification level which unlocks a second, sensitive, portion of the dataset. The screen may then be toggled to display the second, sensitive, portion of the dataset. In some embodiments, the user may toggle the display back and forth between the two portions of the dataset.

In one embodiment of the TUI, the first signal may include correct entry of a password in an input/output (“I/O”) component of the TUI. In another embodiment, the first signal may include correct entry of a personal identification number (“PIN”) in the I/O component.

In yet another embodiment, the first signal may include recognition of a trusted user access. For example, if a user successfully enters a password and achieves the first level of verification status, subsequent attempts by the user to access the first subset of the dataset may not require a password entry.

In still another embodiment, the first signal may include biometric authentication. Biometric authentication may include a fingerprint, retina scan, heartbeat/pulse recognition, facial, and visual or audio recognition. Biometric authentication may include any suitable computer-achieved recognition of a distinguishing character associated with a biometric of a user.

In certain embodiments of the TUI, the second signal may include correct entry of a password in an I/O component of the TUI. In another embodiment, the second signal may include correct entry of a PIN in the I/O component. In yet another embodiment, the second signal may include biometric authentication. In still another embodiment, the second signal may include correct entry, in an input/output (“I/O”) component of the TUI, of a temporary passcode that was transmitted to a device for two-step authentication.

For example, a user may enter a preset password to access an app to achieve the first verification level. In order to access the second, sensitive, subset of the dataset, the user may be required to enter a passcode to achieve the second verification level. The passcode may be a temporary passcode formulated for this particular access session. The temporary passcode may be texted, emailed, or otherwise transmitted to a verified account or device associated with the user.

In some embodiments, the dataset may include a sequence of numbers associated with a payment instrument. The sequence of numbers may include a 16-digit account number associated with the payment instrument. The sequence of numbers may also include an expiration date associated with the payment instrument, and a card verification value (“CVV”) associated with the payment instrument. A CVV is typically formulated at least in part based on the expiration date. The term CVV as used herein may be synonymous with CVV2, card security code (“CSC”), card verification data (“CVD”), card verification number (“CVN”), or card verification code (“CVC”).

In certain embodiments of the TUI, the first subset of the dataset may include the last 4 digits of a 16-digit account number associated with a payment instrument. The first subset of the dataset may also include an expiration date associated with the payment instrument and/or a CVV associated with the payment instrument.

In some embodiments of the TUI, the second subset of the dataset may include all the digits of a 16-digit account number associated with a payment instrument. The second subset of the dataset may further include an expiration date associated with the payment instrument and a CVV associated with the payment instrument.

Display of the second subset of the dataset may provide data for executing online transactions, and/or for executing transactions at card-less automated teller machines (“ATM”). For example, a user may be able to enter information contained in the second subset at an online vendor to make a purchase. A user may also be able to use the information to provision a payment instrument to a digital wallet.

In certain embodiments of the TUI, the payment instrument may be a debit card. In some embodiments, the payment instrument may be a temporary payment instrument. The temporary payment instrument may be a digital version of a tangible payment instrument. The temporary payment instrument may be a digital payment instrument that is independent of a physical embodiment. The temporary payment instrument and the tangible payment instrument may share an account number, and differ with respect to an expiration date and a CVV. In some embodiments, the CVV and/or the expiration date may be the same for the temporary and the tangible payment instruments. In still other embodiments, the account number may be different for the temporary and the tangible payment instruments.

In some embodiments, the temporary payment instrument may be associated with an expiration date that is 30 days after the creation of the temporary payment instrument. In other embodiments, the temporary payment instrument may be associated with an expiration date that is any suitable amount of time from the creation of the temporary payment instrument. For example, the expiration date may be 7, 10, 14, 21, 45, 60, 90 or any other suitable number of days after the creation of the temporary payment instrument. The expiration date may be at the end of a month or billing cycle. The temporary payment instrument may expire less than four years, or any other suitable amount of time, after its creation. Four years may be the typical life-span of a tangible payment instrument.

In certain embodiments, the temporary payment instrument may be deactivated when a tangible payment instrument associated with the temporary payment instrument is activated. The tangible payment instrument may, in some embodiments, be periodically or substantially continuously monitored for activation. For example, the tangible payment instrument may be monitored once a day. The monitoring may coincide with batch processing activity. In another example, the tangible payment instrument may be monitored every time an attempt is made to access information regarding the temporary payment instrument. In yet another example, an alert may be issued when the tangible payment instrument is activated.

In certain other embodiments, the payment instrument may be the tangible payment instrument. Upon achieving the second level of verification status, the screen may be toggle-able to display a second, sensitive subset associated with the tangible payment instrument. This feature may be provided for a stand-alone tangible payment instrument. The feature may also be provided for a tangible payment instrument associated with a digital payment instrument. In this embodiment, the TUI may display the second subset of the digital payment instrument when that is active, and seamlessly transition to display the second subset of the tangible payment instrument when it is activated and the digital one is deactivated.

In some embodiments, the TUI may include a digital wallet. A digital wallet may be a program or app. The digital wallet may store payment instrument information. The digital wallet may use tokenization methods to represent payment instruments. Tokenization methods may provide payment instrument operability with limited or no transfer of sensitive information. The digital wallet may be used to execute transactions, such as purchases, both in brick-and-mortar stores and online.

In certain embodiments of the TUI, the digital wallet may be updated to include the temporary payment instrument. Updating the digital wallet may require manually selecting an update option. Updating the digital wallet may be accomplished automatically, absent the need for user activity.

In some embodiments, updating the digital wallet may include adding the temporary payment instrument to the digital wallet. In other embodiments, updating the digital wallet may include replacing an old payment instrument stored in the digital wallet with the temporary payment instrument. The old payment instrument may be a previous version of the temporary payment instrument.

In certain embodiments of the TUI, when a tangible payment instrument associated with the temporary payment instrument is activated, the digital wallet may be further updated to include the tangible payment instrument. The further update of the digital wallet may replace the temporary payment instrument with the tangible payment instrument. The replacing may be accomplished automatically. Automatic replacement may be completed without manually re-provisioning the digital wallet.

One or more non-transitory computer-readable media storing computer-executable instructions are provided. When executed by a processor on a computer system, the instructions may perform a method for displaying distinct subsets of a dataset.

The method may include receiving a first signal. In response to the first signal, the method may include upgrading a verification status from a default level to a first level. When the verification status is at the first level, the method may include displaying on a screen a first subset of the dataset. In response to a second signal, the method may include upgrading the verification status from the first level to a second level. When the verification status is at the second level, the method may include augmenting the screen with the ability to toggle to display a second, sensitive, subset of the dataset.

A multiple-level verification system is provided. The system may be for authorizing display of varying levels of a dataset. The dataset may include sensitive payment instrument information.

The system may include an authentication module. The authentication module may be configured to transmit signals. The authentication module may also be configured to establish a level of verification status. In response to a first criterion, the authentication module may upgrade the verification status from a default level to a first level. When the verification status is at the first level, the authentication module may transmit a first signal to a device to allow display of a first, partial, subset of the dataset. In response to a second criterion, the authentication module may upgrade the verification status from the first level to a second level. When the verification status is at the second level, the authentication module may transmit a second signal to the device to allow display of a second, sensitive, subset of the dataset.

In some embodiments, the first criterion may include correct entry of a password. In certain embodiments, the second criterion may include correct entry of a temporary passcode that was transmitted to a device for two-step authentication.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

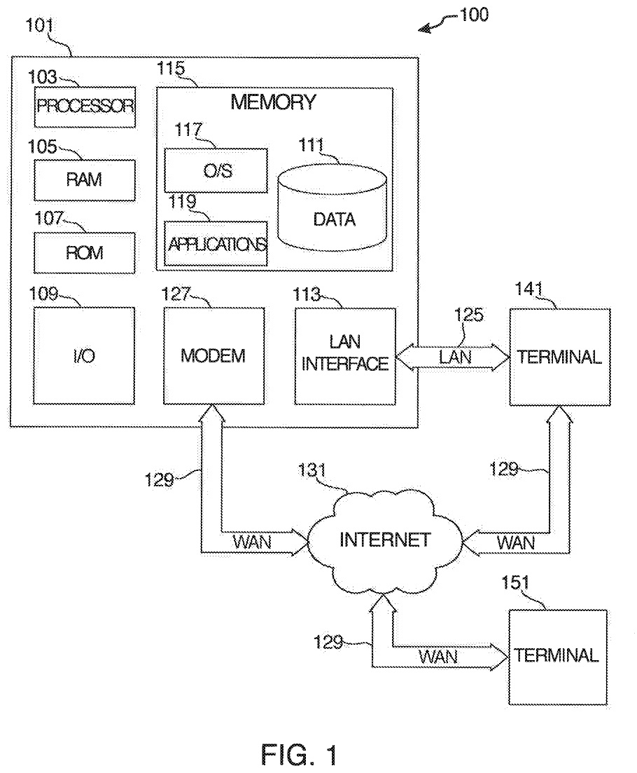

FIG. 1 shows an illustrative block diagram of system 100 that includes computer 101. Computer 101 may alternatively be referred to herein as a “server” or a “computing device.” Computer 101 may be a desktop, laptop, tablet, smart phone, or any other suitable computing device.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may be comprised of any suitable permanent storage technology—e.g., a hard drive. The memory 115 stores software including the operating system 117 any application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions may be embodied in hardware or firmware (not shown). The computer 101 may execute the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input may be included in a transfer event or an escape event. The input/output module may also include one or more speakers for providing audio output and a video display device for providing textual, audio, audiovisual, and/or graphical output. The I/O module may include any screen or display suitable for showing graphics, text, numbers, and/or The input and output may be related to computer application functionality.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server.

The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory. The transmission of the data together with computer-readable instructions may enable the computer system to quickly retrieve the data, when needed. Because the computer system is able to quickly retrieve the data, the web-based server may not need to stream the data to the computer system. This may be beneficial for the computer system, because the retrieval may be faster than data-streaming. Users may not become frustrated because they do not need to wait to run the applications. Conventionally, streaming data requires heavy usage of the processor and the cache memory. If the data is stored in the computer system's memory, retrieval of the data may not require heavy processor and cache memory usage. Any of various conventional web browsers can be used to display and manipulate retrieved data on web pages.

Additionally, application program(s) 119, which may be used by computer 101, may include computer executable instructions for invoking user functionality related to communication, such as e-mail, Short Message Service (SMS), and voice input and speech recognition applications. Application program(s) 119 (which may be alternatively referred to herein as “applications” or “apps”) may include computer executable instructions for invoking user functionality related performing various tasks. The various tasks may be related to the user's finances, shopping, recreation, relationships, or other business or personal affairs.

Computer 101 and/or terminals 141 and 151 may also be devices including various other components, such as a battery, speaker, and/or antennas (not shown).

Terminal 151 and/or terminal 141 may be portable devices such as a laptop, cell phone, Blackberry™, tablet, smartphone, or any other suitable device for receiving, storing, transmitting and/or displaying relevant information. Terminals 151 and/or terminal 141 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement services provided by the central application, secondary applications, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

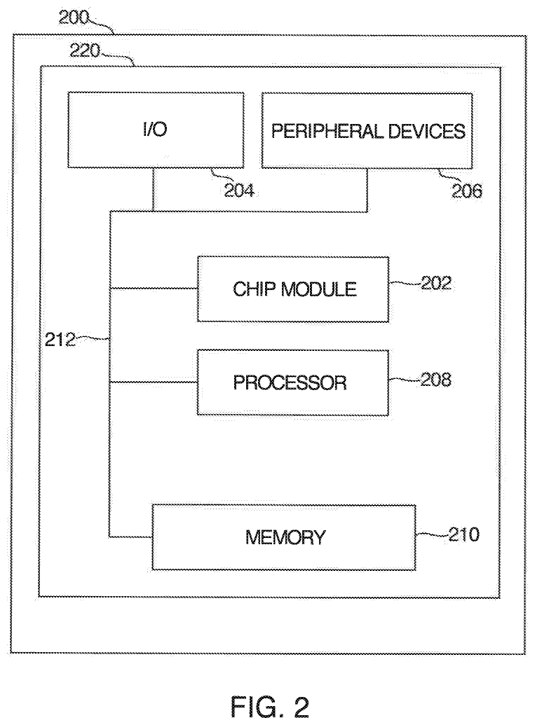

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

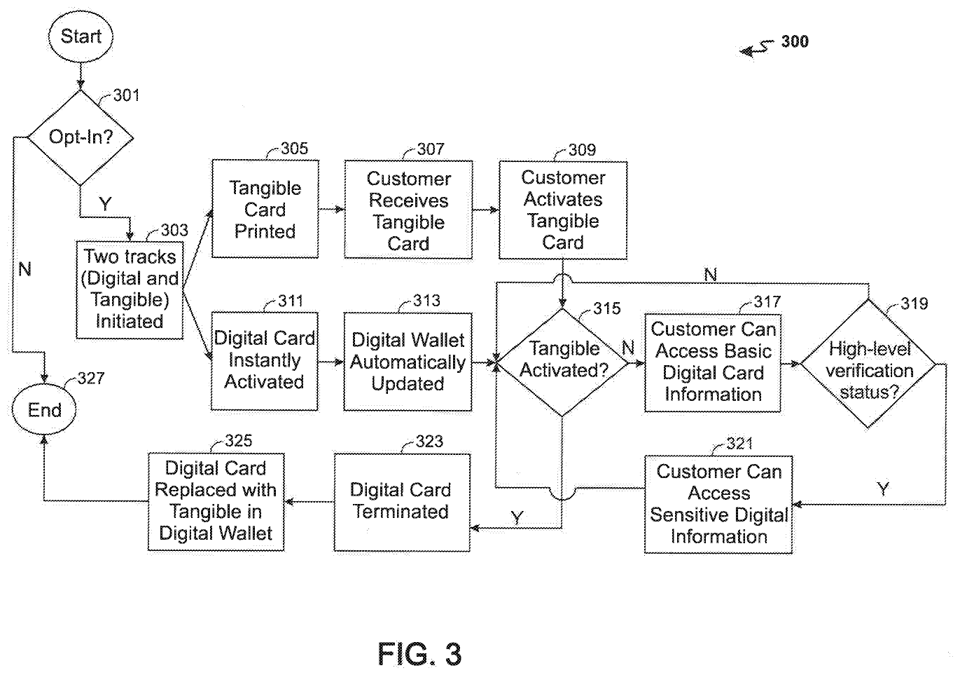

FIG. 3 shows illustrative flowchart 300 of a process in accordance with principles of the disclosure. Flowchart 300 represents one embodiment. Flowchart 300 may include steps that are optional, and may omit steps that are present in other embodiments. The ordering of the steps may differ in other embodiments as well.

Flowchart 300 may start at step 301. Step 301 queries whether there was an “opt-in.” If an opt-in is detected, the process may continue with step 303. If an opt-in is not detected, the process may end at step 327.

An example of a qualifying opt-in may occur during use of a banking app. The app may process a request for a payment instrument for a user. The user may be a customer. The payment instrument may be a new payment instrument or a replacement payment instrument. The payment instrument may be a debit card. It may be established that the user qualifies for a temporary, digital payment instrument. The digital payment instrument may be configured to be used prior to activation of a tangible payment instrument.

The threshold to qualify for a digital payment instrument may be different than the threshold to qualify for a tangible payment instrument. The digital payment instrument threshold may be higher than that of a tangible payment instrument. Qualifying for a digital payment instrument may require a certain credit score, a certain level of confidence of identity authentication, little or no suspicion of historical fraudulent activity, or any other suitable qualification threshold. Qualifying for a digital payment instrument may require a device with a digital wallet. A user may be prompted to download a digital wallet to qualify.

A qualifying user may be offered an option to opt-in to a digital payment instrument. The option may be offered on a screen while using an app. The option may also be offered via a website, program, in person, or during the course of a telephone conversation. Selecting this option may qualify as an opt-in.

If an opt-in has been detected, the process may continue with step 303. Step 303 includes the initiation of two tracks. One track represents the flow for the tangible payment instrument, and the other track represents the flow for the digital payment instrument. Initiation of the two tracks may include creation of two accounts. The two accounts may be one account internally. The two accounts may share an account number. The account number may be a 16-digit card number. The two accounts may differ in their respective expiration dates and CVVs. In some embodiments, the two accounts may share one, some or all of an account number, CVV, and expiration date. The expiration date associated with the tangible payment instrument may be set to allow a four-year lifespan, or any other suitable amount of time. The expiration date associated with the digital payment instrument may be set to allow for a shorter lifespan than the tangible payment instrument. The lifespan of the digital payment instrument may be set for 30 days. Once initiated, the two tracks may proceed in parallel. Alternatively, the 4-year period may initiate after the expiration or termination of the digital payment instrument. In other embodiments, the tangible payment instrument and the digital payment instrument may share all or none of their account numbers, expiration dates, and CVVs.

The tangible payment instrument track may proceed with step 305. At step 305, the tangible payment instrument may be printed or otherwise formed. At step 307 a customer may receive the tangible payment instrument. At step 309 the customer may activate the tangible payment instrument. The process may then feed into step 315, discussed further below.

The digital payment instrument track may proceed with step 311. At step 311, the digital payment instrument is activated. The activation may be immediately subsequent to the opt-in and initialization of the digital payment instrument.

The digital payment instrument track may proceed further with step 313. Step 313 may include updating a digital wallet with the digital payment instrument. The update may add the digital payment instrument to the digital wallet. The update may replace an existing payment instrument (e.g. an expired or cancelled version of the digital payment instrument) with the digital payment instrument. The update may be executed absent any user activity. Alternatively, the update may be executed partially or completely manually. The update may involve re-provisioning the wallet. Re-provisioning the wallet may involve updating and/or creating tokens.

The process may continue to step 315. Step 315 queries whether the tangible payment instrument has been activated. The query may be periodic, event-based (e.g. attempted access of the dataset, or receipt of an alert that the tangible payment instrument was activated), or substantially continuous. If it is determined that the tangible payment instrument has been activated, the process may continue to step 323.

At step 323, the digital payment instrument is terminated. In some embodiments, the digital payment instrument may not be terminated, and may remain active until expiration. The process may continue with step 325.

At step 325, the digital wallet is updated with the tangible payment instrument. The update may add the tangible payment instrument to the digital wallet. The update may replace the digital payment instrument with the tangible payment instrument. The update may be executed absent any user activity. Alternatively, the update may be executed partially or completely manually. The update may involve re-provisioning the wallet. Re-provisioning the wallet may involve updating and/or creating tokens. Following step 325, the process may end at step 327.

At step 315, when the process queries if the tangible payment instrument has been activated, if no activation is detected the process may proceed to step 317. At step 317 the customer can access the first subset of the dataset. The first subset may include basic card information, such as the last four digits of an account number. The customer may only be able to access the first subset if a first level of verification has been achieved. The process may continue with step 319.

Step 319 queries if a high-level verification status has been established. A high-level verification status may be the second verification level, and may require a criterion such as entry of a passcode. If a high-level has been achieved, the process may proceed to step 321, allowing the customer access to a second subset of the dataset. The second subset may include sensitive information, such as the full 16-digit account number, expiration date, and CVV of the digital payment instrument.

In some embodiments, steps 317-321 (i.e., displaying the second subset upon achieving a high-level verification) may be provided for a tangible card as well.

From step 321, the process may revisit step 315, inquiring once again whether the tangible card has been activated. In some embodiments, the process may revisit step 319, to recheck the level of verification. The revisiting may be substantially continuously, periodically, or event-based. For example, the customer may be allowed access to the second subset for the duration of a logged-on session.

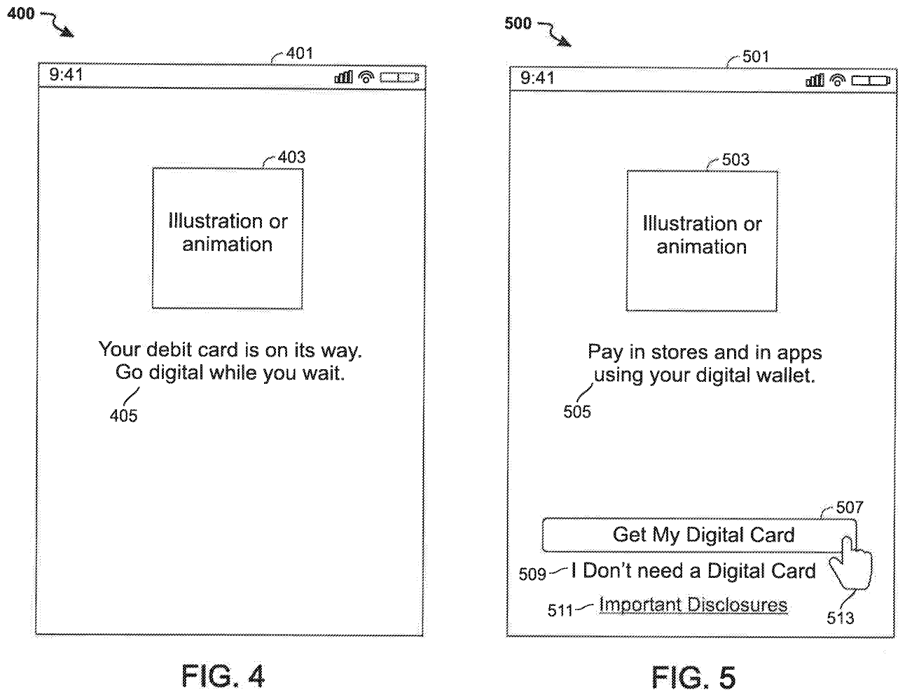

FIG. 4 shows an illustrative system 400 that includes screen 401. Screen 401 shows an exemplary “opt-in” option for a digital payment instrument. The digital payment instrument may be a debit card. Screen 401 may be displayed to a user who qualifies for a digital debit card. For example, the user may have requested and been approved for a new or replacement tangible debit card. The user may also satisfy any suitable prerequisite qualification for a digital card.

Screen 401 may show graphic 403. Graphic 403 may include any suitable illustration, logo, or animation. Screen 401 may also show text 405. Text 405 may read: “Your debit card is on its way. Go digital while you wait.” Text 405 may be a message offering a qualifying user to opt-in to a digital debit card. The “opt-in” offer may display a sequence of screens shown in FIGS. 5-7. The sequence of screens may be shown in any order. The sequence of screens may include additional screens and/or information not shown in FIG. 4 or 5-7.

FIG. 5 shows an illustrative system 500 that includes screen 501. Screen 501 shows an exemplary “opt-in” option for a digital payment instrument. Screen 501 may be a continuation of the opt-in option of screen 401 (FIG. 4, above).

Screen 501 may show graphic 503. Graphic 503 may include any suitable illustration or animation. Screen 501 may also show text 505. Text 505 may read: “Pay in stores and in apps using your digital wallet.” Text 505 may be a message touting advantages of the digital card. Screen 501 may also include bars 507 and 509. Bar 507 may read “Get My Digital Card.” Selecting bar 507 (e.g. by clicking on it with cursor 513) may constitute an opt-in to the digital card. Bar 509 may read “I Don't Need a Digital Card.” Selecting bar 509 may not opt-in to the digital card. Text 511, “Important Disclosures,” may be selectable. Selecting text 511 may provide the user with additional information.

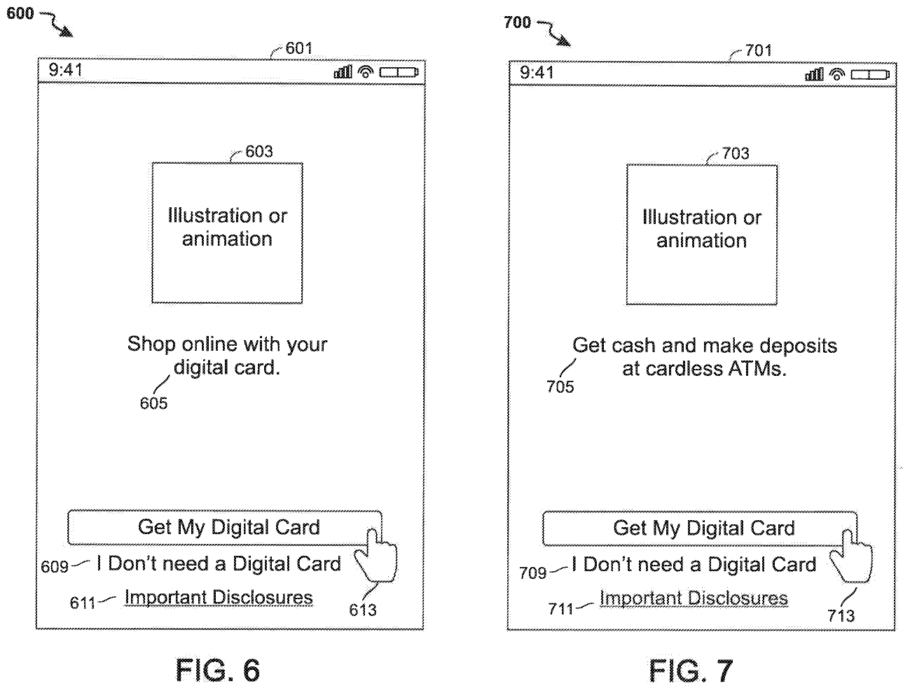

FIG. 6 shows an illustrative system 600 that includes screen 601. Screen 601 shows an exemplary “opt-in” option for a digital payment instrument. Screen 601 may be a continuation of the opt-in option of screen 501 (FIG. 5, above).

Screen 601 may show graphic 603. Graphic 603 may include any suitable illustration or animation. Screen 601 may also show text 605. Text 605 may read: “Shop online with your digital card.” Text 605 may be a message touting advantages of the digital card. Screen 601 may also include bars 607 and 609. Bar 607 may read “Get My Digital Card.” Selecting bar 607 (e.g. by clicking on it with cursor 613) may constitute an opt-in to the digital card. Bar 609 may read “I Don't Need a Digital Card.” Selecting bar 609 may not opt-in to the digital card. Text 611, “Important Disclosures,” may be selectable. Selecting text 611 may provide the user with additional information.

FIG. 7 shows an illustrative system 700 that includes screen 701. Screen 701 shows an exemplary “opt-in” option for a digital payment instrument. Screen 701 may be a continuation of the opt-in option of screen 601 (FIG. 6, above).

Screen 701 may show graphic 703. Graphic 703 may include any suitable illustration or animation. Screen 701 may also show text 705. Text 705 may read: “Get cash and make deposits at cardless ATMs.” Text 705 may be a message touting advantages of the digital card. Screen 701 may also include bars 707 and 709. Bar 707 may read “Get My Digital Card.” Selecting bar 707 (e.g. by clicking on it with cursor 713) may constitute an opt-in to the digital card. Bar 709 may read “I Don't Need a Digital Card.” Selecting bar 709 may not opt-in to the digital card. Text 711, “Important Disclosures,” may be selectable. Selecting text 711 may provide the user with additional information.

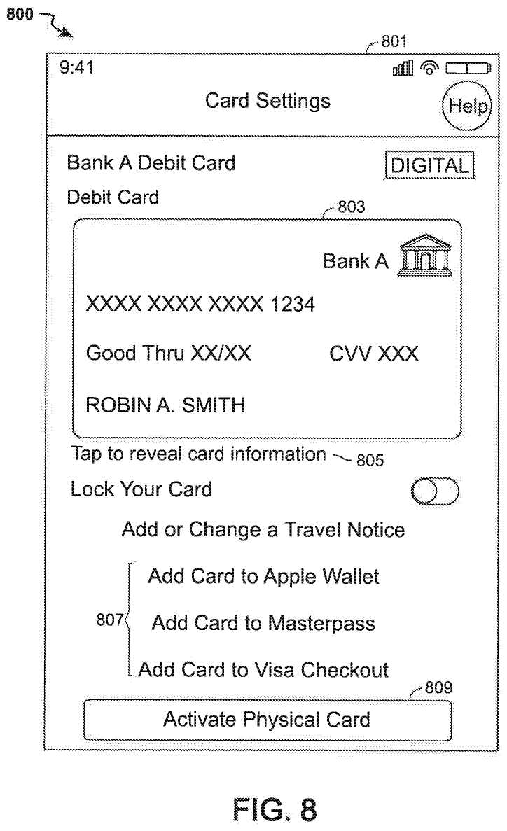

FIG. 8 shows an illustrative system 800 that includes screen 801. Screen 801 shows an exemplary toggle-able user interface. Screen 801 may show data 803. Data 803 may contain payment instrument information. Data 803 may, when at a first verification level, include the last 4 digits of an account number.

Text 805 may read “Tap to reveal card information.” Text 805 may be selectable (e.g. by tapping the text). In an alternative embodiment, data 803, or any other suitable element, may be selectable to indicate an attempt to access more sensitive data. Selecting text 805, or otherwise indicating an attempt to access sensitive data, may toggle the display to show the sensitive data. Sensitive data may include the full 16-digit account number, expiration date, and CVV. The screen may only toggle to display the sensitive data when a high level of verification is established (e.g. through entry of a temporary passcode in a two-step authentication.) Once established, the display may be toggle-able for the duration of a mobile application usage session. Selecting text 805, or otherwise indicating an attempt to access sensitive data, may trigger activity that may lead to establishing a high level of verification. For example, a temporary passcode may be created and sent to a device associated with the user.

Options 807 may include selectable actions. The selectable actions may include options to add the digital card to various digital wallets.

Bar 809 may read “Activate Physical Card.” Bar 809 may be selectable.

Selecting bar 809 may activate a tangible version of the digital card. A user may select bar 809 upon receipt of the tangible card (e.g. via mail). Selecting bar 809 and activating the tangible card may terminate the digital card. Activating the tangible card may, automatically or otherwise, update a digital wallet to replace the digital card with the tangible card.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and apparatus for high-security toggle systems for use with payment instrument displays are provided. Persons skilled in the art will appreciate that the present invention can be practiced by other than the described embodiments, which are presented for purposes of illustration rather than of limitation. The present invention is limited only by the claims that follow.

What is claimed is:

1. A high-security toggle-able user interface (“TUI”) for immediate display of distinct subsets of a dataset, the TUI comprising:
a verification module configured to receive a plurality of signals and establish a level of verification status; and
a screen for displaying data;
wherein:
in response to a first signal, the verification module upgrades the verification status from a default level to a first level;
when the verification status is at the first level, the screen displays a first, partial, subset of the dataset;
in response to a second signal, the verification module upgrades the verification status from the first level to a second level; and
when the verification status is at the second level, the screen is augmented with the ability to toggle to display a second, sensitive, subset of the dataset.

2. The TUI of claim 1, wherein the first signal and/or the second signal include one or more of:
correct entry of a password in an input/output (“I/O”) component of the TUI;
correct entry of a personal identification number (“PIN”) in an I/O component of the TUI;
biometric authentication; and
recognition of a trusted user access.

3. The TUI of claim 1, wherein the second signal includes correct entry, in an input/output (“I/O”) component of the TUI, of a temporary passcode that was transmitted to a device for two-step authentication.

4. The TUI of claim 1, wherein the dataset comprises a sequence of numbers associated with a payment instrument.

5. The TUI of claim 4, wherein the sequence of numbers includes one or more of:
a 16-digit account number associated with the payment instrument;
an expiration date associated with the payment instrument; and
a card verification value (“CVV”) associated with the payment instrument.

6. The TUI of claim 5, wherein the first subset of the dataset includes the last 4 digits of the 16-digit account number.

7. The TUI of claim 5, wherein the second subset of the dataset includes all the digits of the 16-digit account number.

8. The TUI of claim 7, wherein the second subset of the dataset further includes the expiration date and the CVV.

9. The TUI of claim 4, wherein display of the second subset of the dataset provides sufficient data for:
executing online transactions; and/or
executing transactions at card-less automated teller machines (“ATM”).

10. The TUI of claim 4, wherein the payment instrument is a debit card.

11. The TUI of claim 4, wherein:
the payment instrument is a temporary payment instrument;
the temporary payment instrument is a digital version of a tangible payment instrument; and
the temporary payment instrument and the tangible payment instrument share an account number, and differ with respect to an expiration date.

12. The TUI of claim 11, wherein the temporary payment instrument is associated with an expiration date that is 30 days from the creation of the temporary payment instrument.

13. The TUI of claim 11, wherein the temporary payment instrument is deactivated when the tangible payment instrument is activated.

14. The TUI of claim 13, wherein the tangible payment instrument is periodically or substantially continuously monitored for activation.

15. The TUI of claim 11, wherein the temporary payment instrument is a digital payment instrument independent of a physical embodiment.

16. The TUI of claim 11, further comprising a digital wallet, wherein the digital wallet is updated to include the temporary payment instrument, and updating the digital wallet includes replacing an old payment instrument with the temporary payment instrument, said old payment instrument being a previous version of the temporary payment instrument.

17. The TUI of claim 16, wherein, when a tangible payment instrument associated with the temporary payment instrument is activated, the digital wallet is further updated to include the tangible payment instrument, and the further update of the digital wallet replaces the temporary payment instrument with the tangible payment instrument.

18. The TUI of claim 17, wherein the update and the further update are executed without a need to manually re-provision the digital wallet.

19. One or more non-transitory computer-readable media storing computer-executable instructions which, when executed by a processor on a computer system, perform a method for instantaneous, high-security display of distinct subsets of a dataset, the method comprising:
receiving a first signal;
in response to the first signal, upgrading a verification status from a default level to a first level;
when the verification status is at the first level, displaying on a screen a first subset of the dataset;
in response to a second signal, upgrading the verification status from the first level to a second level; and
when the verification status is at the second level, augmenting the screen with the ability to toggle to display a second, sensitive, subset of the dataset.

20. A multiple-level verification system for authorizing instantaneous display of varying levels of a dataset comprising sensitive payment instrument information, said system comprising an authentication module configured to:
in response to a first criterion, upgrade a verification status from a default level to a first level;
when the verification status is at the first level, transmit a first signal to a device to allow display of a first, partial, subset of the dataset;
in response to a second criterion, upgrade the verification status from the first level to a second level; and
when the verification status is at the second level, transmit a second signal to the device to allow display of a second, sensitive, subset of the dataset.

21. The system of claim 20, wherein the first criterion includes correct entry of a password.

22. The system of claim 20, wherein the second criterion includes correct entry of a temporary passcode that was transmitted to a device for two-step authentication.
